(19) United States
(12) Patent Application Publication
(10) Pub. No.: US 2013/0050309 A1
(43) Pub. Date: Feb. 28, 2013

(54) LIQUID EJECTING APPARATUS AND LIQUID EJECTING APPARATUS MAINTENANCE METHOD

(71) Applicants: Kaoru Koike, Matsumoto-shi (JP); Masaaki Ando, Matsumoto-shi (JP)

(72) Inventors: Kaoru Koike, Matsumoto-shi (JP); Masaaki Ando, Matsumoto-shi (JP)

(73) Assignee: SEIKO EPSON CORPORATION, Tokyo (JP)

(21) Appl. No.: 13/592,196

(22) Filed: Aug. 22, 2012

(30) Foreign Application Priority Data
Aug. 23, 2011 (JP) 2011-181293

(51) Int. Cl. B41J 29/38

(52) U.S. Cl. 347/6

(57) ABSTRACT

A liquid ejecting apparatus includes a liquid storing unit, a pressure adjusting unit that adjusts a pressure in the liquid storing unit, a circulation flow path that returns the liquid that has flowed out from the liquid storing unit to the liquid storing unit, a circulating unit that circulates the liquid in the circulation flow path, a head provided halfway on the circulation flow path and capable of ejecting the liquid through a plurality of nozzle openings, a cap of the head, and a control unit that depressurizes an inner portion of the liquid storing unit to a pressure lower than an atmospheric pressure with the pressure adjusting unit when liquid in the circulation flow path is circulated with the circulating unit in a state where the cap is made to abut against the nozzle opening surface of the head so as to seal the plurality of nozzle openings.

### BACKGROUND

1. Technical Field

The present invention relates to a liquid ejecting apparatus and a liquid ejecting apparatus maintenance method.

2. Related Art

As an example of a liquid ejecting apparatus, an ink jet printer (hereinafter, printer) which ejects ink (liquid) through nozzle openings provided in a head has been known. In such a printer, ink in ink chambers which communicate with nozzles and which are filled with the ink is pressurized so that the ink is ejected through the nozzle openings. Therefore, if air bubbles are mixed into ink in the head or an ink flow path, the following problems occur. That is, the ink cannot be pressurized appropriately and ejection failure occurs, and the air bubbles inhibit the flow of the ink and a sufficient amount of ink cannot be supplied to the head.

In order to solve the problems, a printer has been proposed in which ink in an ink flow path which connects an ink tank for storing ink and a head is circulated and air bubbles mixed into the ink in the head and the ink flow path are transferred to the ink tank together with the ink (for example, see JP-A-11-198403). In the ink tank, the air bubbles will burst on a liquid surface and disappear so that the air bubbles can be removed from the ink.

However, fine air bubbles mixed into ink are difficult to flow with the current of ink. Therefore, there has arisen a problem in that the fine air bubbles remain in corner portions, narrow spaces, and the like in a head and an ink flow path. Further, the fine air bubbles do not go up to a liquid surface and are kept mixed into the ink in an ink tank. Then, the ink containing the fine air bubbles is undesirably transferred from the ink tank to the head and the ink flow path.

### SUMMARY

An advantage of some aspects of the invention is to improve air bubble removing performance from liquid (ink).

A liquid ejecting apparatus according to an aspect of the invention includes a liquid storing unit that stores liquid, a pressure adjusting unit that adjusts a pressure in the liquid storing unit, a circulation flow path that returns the liquid that has flowed out from the liquid storing unit to the liquid storing unit again, a circulating unit that circulates the liquid in the circulation flow path, a head that is provided halfway in the circulation flow path and is capable of ejecting the liquid through a plurality of nozzle openings, a cap that is capable of abutting against a nozzle opening surface of the head, and a control unit that depressurizes an inner portion of the liquid storing unit to a pressure lower than an atmospheric pressure with the pressure adjusting unit when the liquid in the circulation flow path is circulated with the circulating unit in a state where the cap is made to abut against the nozzle opening surface of the head so as to seal the plurality of nozzle openings.

Other characteristics of the aspect of the invention will be clarified from the present specification and accompanying drawings.

### BRIEF DESCRIPTION OF THE DRAWINGS

The invention will be described with reference to the accompanying drawings, wherein like numbers reference like elements.

FIG. 1 is a block diagram illustrating an overall configuration of a printer.

FIG. 2 is a schematic top view illustrating the printer.

FIG. 3 is a view for explaining a maintenance unit.

FIG. 4 is a flow illustrating a maintenance method.

FIGS. 5A and 5B are views illustrating a state where air bubbles mixed into ink are removed.

FIG. 6 is a view for explaining an ink circulation path in a modification.

### DESCRIPTION OF EXEMPLARY EMBODIMENTS

### Outline of Disclosure

At least the following will be clarified through the description in this specification and the content of accompanying drawings.

A liquid ejecting apparatus includes a liquid storing unit that stores liquid, a pressure adjusting unit that adjusts a pressure in the liquid storing unit, a circulation flow path that returns the liquid that has flowed out from the liquid storing unit to the liquid storing unit again, a circulating unit that circulates the liquid in the circulation flow path, a head that is provided halfway in the circulation flow path and is capable of ejecting the liquid through a plurality of nozzle openings, a cap that is capable of abutting against a nozzle opening surface of the head, and a control unit that depressurizes an inner portion of the liquid storing unit to a pressure lower than an atmospheric pressure with the pressure adjusting unit when the liquid in the circulation flow path is circulated with the circulating unit in a state where the cap is made to abut against the nozzle opening surface of the head so as to seal the plurality of nozzle openings individually.

With the liquid ejecting apparatus, air bubbles contained in the liquid in the circulating unit and the head can be made easy to be transferred to the liquid storing unit. Further, the air bubbles can be made easy to disappear in the liquid storing unit. Accordingly, the air bubble removing performance from the liquid can be improved.

In the above liquid ejecting apparatus, the control unit circulates the liquid in the circulation flow path with the circulating unit, and then, pressurizes the inner portion of the liquid storing unit to a pressure higher than the atmospheric pressure with the pressure adjusting unit so as to cause the liquid to be ejected through the nozzle openings.

With the liquid ejecting apparatus, fine spaces such as nozzles, for example, can be filled with the liquid. Therefore, an appropriate amount of liquid can be ejected through the nozzle openings.

In the above liquid ejecting apparatus, the circulation flow path includes an outbound flow path that makes the liquid that has flowed out from the liquid storing unit flow into the head, and an inbound flow path that returns the liquid that has flowed out from the head to the liquid storing unit.

With the liquid ejecting apparatus, an amount of air bubbles contained in the liquid in the head can be reduced.

A liquid ejecting apparatus maintenance method is performed by the above liquid ejecting apparatus.

With the liquid ejecting apparatus maintenance method, air bubbles contained in the liquid in the circulating unit and the head can be made easy to be transferred to the liquid storing unit. Further, the air bubbles can be made easy to disappear in the liquid storing unit. Accordingly, the air bubble removing performance from the liquid can be improved.

### Printing System

A “liquid ejecting apparatus” is configured as an ink jet printer (hereinafter, printer). An embodiment is described by taking a printing system as an example in which the printer and a computer are connected to each other.

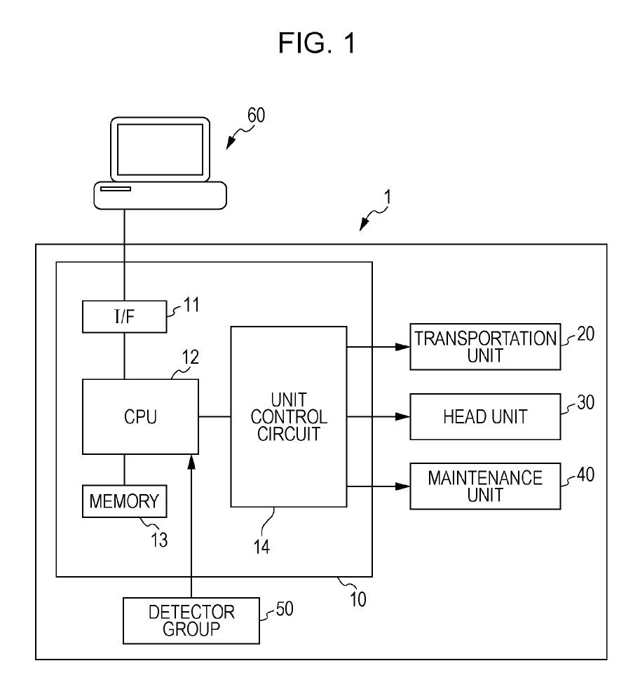

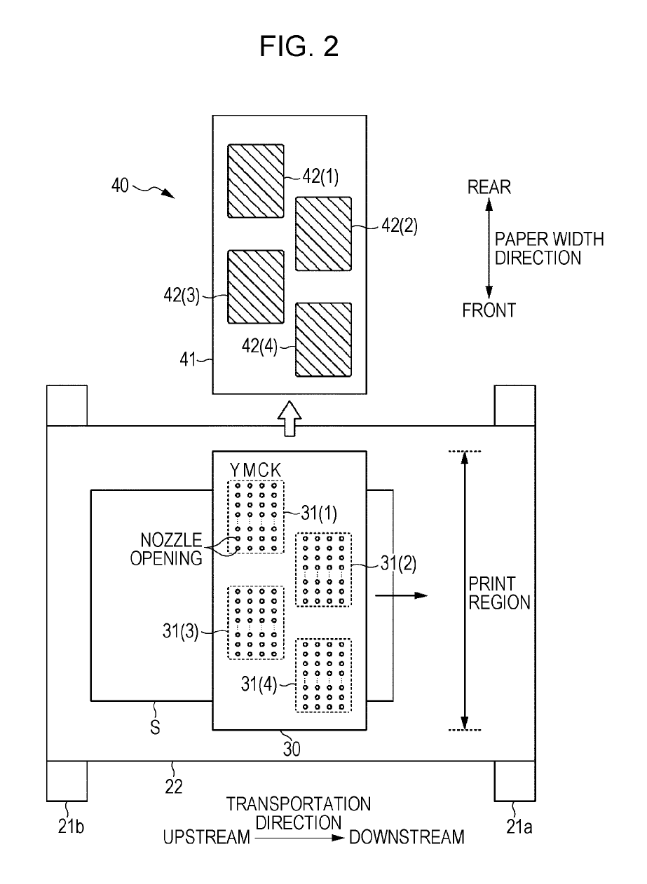

FIG. 1 is a block diagram illustrating an overall configuration of a printer 1. FIG. 2 is a schematic top view illustrating the printer 1. FIG. 2 illustrates arrangement of heads 31 and nozzle openings virtually when seen from the upper side of a head unit 30.

A computer 60 is connected to the printer 1 in a communicable manner. The computer 60 outputs print data to the printer 1 for making the printer 1 print an image.

A controller 10 in the printer 1 controls the printer 1 integrally. An interface portion 11 performs transmission and reception of data between the printer 1 and the computer 60 as an external apparatus. A CPU 12 is an arithmetic processing device for controlling the printer 1 integrally and controls each unit through a unit control circuit 14. A memory 13 secures a region in which programs of the CPU 12 are stored, an operation region, and the like. Further, a state in the printer 1 is monitored by a detector group 50 and the controller 10 controls each unit based on a detection result therefrom.

A transportation unit 20 transports a recording target medium (hereinafter, medium S) such as paper, a fabric, and a film from an upstream side to a downstream side in a transportation direction. As illustrated in FIG. 2, the medium S is transported on a transportation belt 22 which is rotated by transportation rollers 21a, 21b at a constant speed without stopping. At this time, the medium S is transported on the transportation belt 22 while being opposed to the lower surface of the head unit 30.

The head unit 30 ejects ink through nozzle openings onto the opposed medium S. In the printer 1 according to the embodiment, four heads 31(1) to 31(4) which are lined in a paper width direction intersecting with the transportation direction of the medium S are provided on the lower surface of the head unit 30. Nozzle rows for ejecting each of inks of four colors, yellow (Y), magenta (M), cyan (C), and black (K), are provided on a lower surface of each head 31. Nozzle openings through which ink is ejected are lined on each nozzle row at a predetermined interval in the paper width direction. Further, ends of the nozzle rows which are provided on the heads 31 lined in the paper width direction are overlapped with one another. Accordingly, a large number of nozzle openings are lined on the lower surface of the head unit 30 at the predetermined interval in the paper width direction.

If ink is ejected through the nozzle openings onto the medium S which moves under the head unit 30 in the transportation direction, a two-dimensional image on which a plurality of dot rows along the transportation direction are lined in the paper width direction is printed. It is to be noted that an ink ejecting method through the nozzle openings may be a piezoelectric method or a thermal method. In the piezoelectric method, voltage is applied to driving elements (piezoelectric elements) so as to make ink chambers communicating with nozzles expand and contract so that ink is ejected. In the thermal method, air bubbles are generated in nozzles with driving elements (heat generating elements) and ink is ejected with the air bubbles.

A maintenance unit 40 removes air bubbles from ink in the heads 31 and an ink flow path and causes the heads 31 and the ink flow path (details thereof will be described later) to be filled with ink.

### Maintenance Method

### Configuration of Maintenance Unit 40

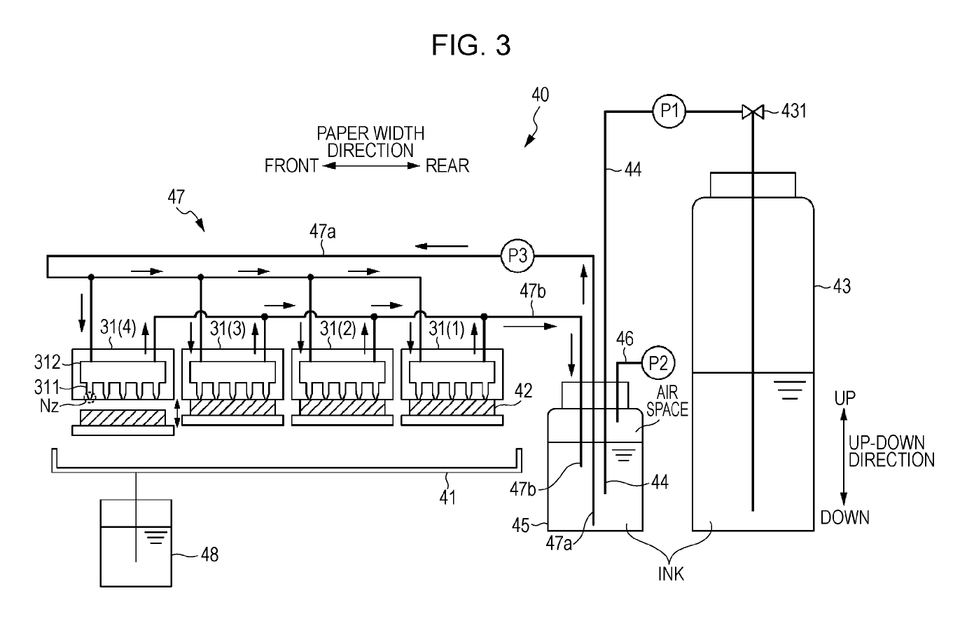

FIG. 3 is a view for explaining the maintenance unit 40. In order to make explanation simple, in FIG. 3, positions of the heads 31 are shifted such that the ends of the heads 31 lined in the paper width direction are not overlapped with one another. As illustrated in FIG. 2, the maintenance unit 40 is positioned at the rear side (non-print region) with respect to a print region to which the medium S is transported in the paper width direction. At the time of maintenance, the head unit 30 moves to the rear side in the paper width direction.

The maintenance unit 40 includes a supply pump P1, a pressure adjusting pump P2, an air tube 46, a circulation pump P3, an ink cartridge 43, a sub tank 45, a supply tube 44, a circulation tube 47, an opening/closing valve 431, an ink receiver 41, a cap 42, and a waste liquid tank 48. The air tube 46 is connected to the pressure adjusting pump P2. The ink cartridge 43 and the sub tank 45 store ink. The supply tube 44 and the circulation tube 47 serve as flow paths of ink. It is to be noted that in the printer 1, the ink cartridge 43, the circulation tube 47, and the like are provided for each of colors (YMCK) which can be discharged by the heads 31. However, since a maintenance method is the same for all the colors, description thereof is commonly made, and each separated description is not made.

The ink cartridge 43 and the sub tank 45 communicate with each other through the supply tube 44. The opening/closing valve 431 and the supply pump P1 are provided halfway on the supply tube 44. Ink in the ink cartridge 43 is supplied to the sub tank 45 with an operation of the supply pump P1.

Both ends of the circulation tube 47 are provided in the sub tank 45. The circulation pump P3 and the four heads 31(1) to 31(4) are provided halfway on the circulation tube 47. With an operation of the circulation pump P3, ink in the sub tank 45 passes through the heads 31 halfway, and is returned to the sub tank 45, again, while flowing in the circulation tube 47. A portion of the circulation tube 47 through which the ink that has flowed out from the sub tank 45 is made to flow into each head 31 is referred to as an “outbound tube 47a.” A portion of the circulation tube 47 through which the ink that has flowed out from each head 31 is returned to the sub tank 45 is referred to as an “inbound tube 47b.” That is to say, ink circulates in the sub tank 45, the outbound tube 47a, the heads 31, the inbound tube 47b, and the sub tank 45 in this order and this path is referred to as an “ink circulation path.” It is to be noted that the circulation pump P3 is located at the upstream side with respect to the heads 31 in the ink circulation path.

Further, an end of the air tube 46 connected to the pressure adjusting pump P2 is provided in an air space (upper side of an ink liquid surface) in the sub tank 45. The pressure adjusting pump P2 discharges the air from the air space in the sub tank 45 so as to depressurize an inner portion of the sub tank 45 to a pressure lower than the atmospheric pressure, or supplies the air to the air space in the sub tank 45 so as to pressurize the inner portion of the sub tank 45 to a pressure higher than the atmospheric pressure.

Nozzles Nz, ink chambers 311, and a common ink chamber 312 are provided on each head 31. Each ink chamber 311 is provided for each nozzle Nz and communicates with each nozzle Nz. The common ink chamber 312 communicates with a plurality of ink chambers 311. Ink from the sub tank 45 is supplied to the common ink chambers 312 of the heads 31 through the outbound tube 47a. Ink in the heads 31 is returned to the sub tank 45 from the common ink chambers 312 through the inbound tube 47b. It is to be noted that each of the outbound tube 47a and the inbound tube 47b is branched halfway so as to communicate with the common ink chambers 312 of the four heads 31(1) to 31(4).

The cap 42 is a member having a substantially rectangular parallel-piped shape (for example, elastic member) and is provided for each head 31. As illustrated in FIG. 2, four caps 42(1) to 42(4) are also lined in the paper width direction so as to correspond to arrangement of the four heads 31(1) to 31(4) on the head unit 30. Accordingly, if the head unit 30 is moved to the non-print region at the time of the maintenance, a state where nozzle opening surfaces (lower surfaces) of the heads 31 are opposed to the caps 42 is realized. The caps 42 can go up and down in an up-down direction and can make close contact with (abut against) the nozzle opening surfaces of the heads 31. If the caps 42 make close contact with the nozzle opening surfaces of the heads 31, the nozzle openings are sealed independently so as not to communicate with the atmosphere.

The ink receiver 41 is provided at a position opposed to the nozzle opening surfaces of the heads 31 at the time of the maintenance (lower side of the caps 42) and receives ink ejected through the nozzle openings of the heads 31. The ink received by the ink receiver 41 is collected to the waste liquid tank 48.

### Maintenance Method

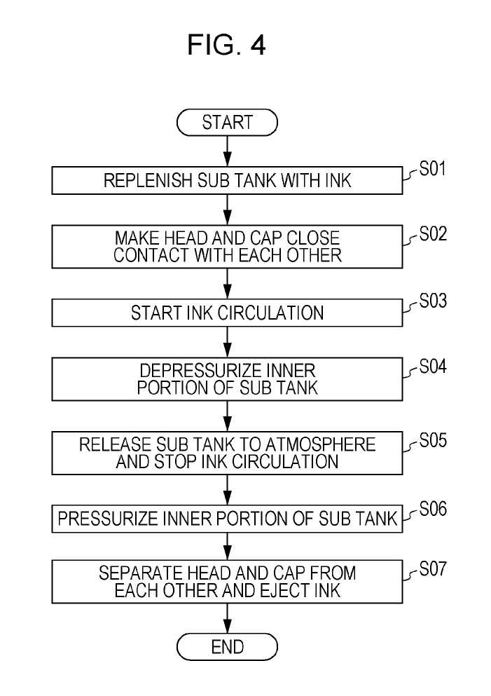

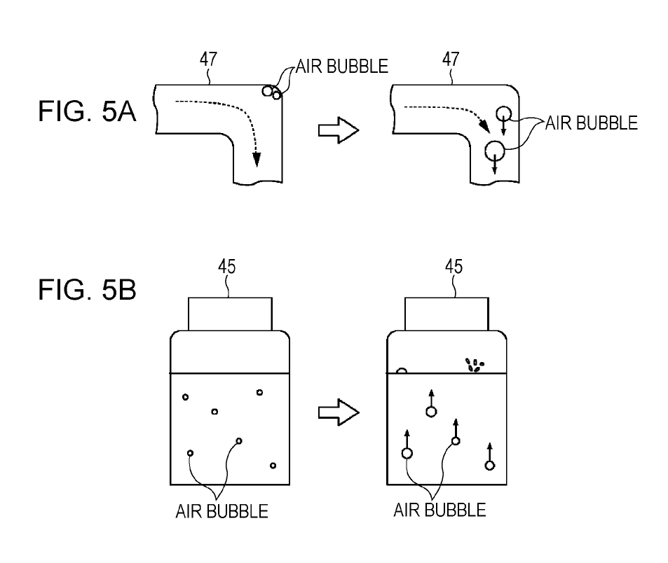

FIG. 4 is a flow illustrating the maintenance method. FIGS. 5A and 5B are views illustrating a state where air bubbles mixed into ink are removed. FIG. 5A illustrates air bubbles that remain in a corner portion of the supply tube 47, and FIG. 5B illustrates air bubbles mixed into ink in the sub tank 45.

When the printer 1 is stopped for a long period of time, the nozzle opening surfaces of the heads 31 and the caps 42 are brought into close contact with each other so as to suppress the air from being mixed through the nozzle openings. However, it is difficult to completely prevent the air from being mixed, and in the printer 1 which has stopped for a long period of time, air bubbles (the air) are mixed into ink in the heads 31 and the ink flow path. Further, when the ink cartridge 43 or the like is replaced, the air is easy to be mixed into the heads 31 and the ink flow path.

If air bubbles are mixed into the heads 31 and the ink flow path, the air bubbles inhibit the flow of ink and ink supply becomes insufficient. Further, in such a case, ink in the ink chambers 311 cannot be pressurized appropriately and the ink is not ejected through the nozzle openings properly.

Then, after the printer 1 in the embodiment has stopped for a long period of time (for example, when an operation is started on one day), and after the ink cartridge 43 or the like has been replaced, maintenance processing of removing air bubbles mixed into the heads 31 and the ink flow path is executed. It is to be noted that timings at which the maintenance processing is executed are not limited to the above-described timings and the maintenance processing may be executed regularly during printing processing, for example. Further, since the heads 31 and the ink flow path are filled with ink with the maintenance processing, the maintenance processing may also be executed in order to initially fill the heads 31 or the ink flow path with ink after the heads 31 or the ink flow path have (has) been washed or replaced, for example.

Hereinafter, specific flow of the maintenance processing is described.

First, the controller 10 of the printer 1 opens the opening/closing valve 431 provided halfway on the supply tube 44 and operates the supply pump P1 so as to replenish the sub tank 45 with a predetermined amount of ink from the ink cartridge 43 to (S01). After the sub tank 45 has been completely replenished with the ink, the controller 10 closes the opening/closing valve 431 so as to suppress ink from flowing between the ink cartridge 43 and the sub tank 45.

Next, the controller 10 makes the nozzle opening surfaces of the heads 31 and upper surfaces of the caps 42 be opposed to each other, and then, makes the caps 42 go up so as to bring the nozzle opening surfaces of the heads 31 and the caps 42 into close contact with each other (S02). As a result, the nozzle openings on the heads 31 are sealed independently so as not to communicate with the atmosphere.

Next, the controller 10 operates the circulation pump P3 so as to circulate ink in the sub tank 45, the heads 31, and the circulation tube 47 (S03). To be more specific, first, ink in the sub tank 45 is transferred to the heads 31 through the outbound tube 47a in a pressurized manner. Then, the ink in the heads 31 is transferred to the sub tank 45 through the inbound tube 47b in a pressurized manner. It is to be noted that at this time, the air space in the sub tank 45 is at the atmospheric pressure. Further, since the nozzle opening surfaces of the heads 31 and the caps 42 are in close contact with each other, ink is suppressed from leaking from the nozzle openings.

Thus, if ink in the sub tank 45, the heads 31, and the circulation tube 47 is circulated, air bubbles mixed into the ink in the heads 31 and the circulation tube 47 are transferred to the sub tank 45 together with the ink. In the sub tank 45, the air bubbles burst on an ink liquid surface and disappear so that the air bubbles are removed from the ink in the sub tank 45.

However, fine air bubbles mixed into ink are difficult to flow with the current of ink. Therefore, the fine air bubbles remain in corner portions, narrow spaces, junctions of members, and the like in the heads 31 and the circulation tube 47 as illustrated in a left section of FIG. 5A only by circulating the ink with the circulation pump P3. Therefore, the air bubbles cannot be sufficiently removed from the ink in the heads 31 and the circulation tube 47.

Further, also in the sub tank 45, the fine air bubbles are difficult to go up to an ink liquid surface and are kept mixed in the ink as illustrated in a left section of FIG. 5B. Then, the ink in the sub tank 45 containing the fine air bubbles is transferred to the circulation tube 47 and the heads 31 so that the air bubbles cannot be sufficiently removed from the ink in the heads 31 and the circulation tube 47.

In order to solve the problem, next, the controller 10 operates the pressure adjusting pump P2 so as to discharge the air from the air space in the sub tank 45 and depressurizes the inner portion of the sub tank 45 to a pressure lower than the atmospheric pressure (S04). That is to say, ink is circulated while depressurizing the inner portion of the ink circulation path (sub tank 45, circulation tube 47, and heads 31).

If the inner portion of the ink circulation path is depressurized, the fine air bubbles that remain in remaining places (corner portions, narrow spaces, junctions of members) of the air bubbles expand as illustrated in a right section of FIG. 5A. The expanded air bubbles are easy to flow with the current of ink in comparison with the fine air bubbles. Therefore, the air bubbles that remain in the remaining places can be transferred to the sub tank 45. This makes it possible to remove the air bubbles contained in the ink in the heads 31 and the circulation tube 47 more reliably.

Further, if the inner portion of the sub tank 45 is depressurized, the fine air bubbles mixed into the ink in the sub tank 45 expand. The expanded air bubbles have buoyancy larger than that of the fine air bubbles and are easy to go up to the ink liquid surface. Therefore, the air bubbles mixed into the ink in the sub tank 45 can be made to disappear on the liquid surface. Accordingly, the air bubbles contained in the ink in the sub tank 45 can be removed (made to disappear) more reliably. This makes it possible to prevent the ink containing the air bubbles from being transferred from the sub tank 45 to the circulation tube 47 and the heads 31.

In addition, if the inner portion of the sub tank 45 is depressurized, ink can be drawn into the sub tank 45 while transferring the ink with the circulation pump P3 in a pressurized manner. Therefore, flow of the ink to the sub tank 45 can be made faster. A flow speed of the ink in the ink circulation path is made higher so as to make the air bubbles that remain in the remaining places easy to flow with the current of ink. This makes it possible to remove the air bubbles contained in the ink in the heads 31 and the circulation tube 47 more reliably.

It is to be noted that the pressure adjusting pump P2 is made to depressurize the air space in the sub tank 45 in order to depressurize the inner portion of the sub tank 45. With this, a problem where ink flows into the pressure adjusting pump P2 and the pressure adjusting pump P2 is damaged can be prevented from occurring.

Further, in the sub tank 45, an end of the outbound tube 47a is located at the lower side with respect to an end of the supply tube 44 and an end of the inbound tube 47b in the up-down direction. With this, ink that has flowed into the sub tank 45 from the inbound tube 47b and the supply tube 44, that is, ink containing air bubbles, can be suppressed from flowing out from the outbound tube 47a to the heads 31 again. Therefore, the air bubbles contained in the ink in the heads 31 and the circulation tube 47 can be removed more reliably.

Further, in the sub tank 45, the end of the inbound tube 47b is located at the upper side with respect to the end of the supply tube 44 and the end of the outbound tube 47a in the up-down direction. With this, ink containing air bubbles can be made to flow out from the end of the inbound tube 47b to the vicinity of the ink liquid surface. Therefore, the air bubbles contained in the ink that has flowed out from the inbound tube 47b can be made easy to go up to the ink liquid surface. This can make the air bubbles easy to disappear.

After a predetermined amount of ink has been circulated while depressurizing the inner portion of the sub tank 45 with the pressure adjusting pump P2 in this manner, the controller 10 stops the operation of the pressure adjusting pump P2 to release the sub tank 45 to the atmosphere, and stops the operation of the circulation pump P3 so as to stop circulation of the ink (S05).

The ink amount (predetermined amount) to be circulated while depressurizing the inner portion of the sub tank 45 with the pressure adjusting pump P2 is set to an ink amount which is equal to or larger than a volume of the flow path circulated from the sub tank 45 to the sub tank 45, that is, an ink amount which is equal to or larger than an amount of ink contained in the circulation tube 47 and the four heads 31(1) to 31(4). With this, the air bubbles that remain in the ink in the heads 31 and the circulation tube 47 can be transferred to the sub tank 45 while making the air bubbles expand. This makes it possible to remove the air bubbles contained in the ink in the heads 31 and the circulation tube 47 more reliably.

Next, the controller 10 operates the pressure adjusting pump P2 to supply the air to the air space in the sub tank 45 so as to pressurize the inner portion of the sub tank 45 to a pressure higher than the atmospheric pressure (S06). With this, the ink in the sub tank 45 is pressurized and is transferred from the sub tank 45 to the heads 31 so that ink in the heads 31 is also pressurized. Thereafter, the controller 10 lowers the caps 42 which have been in close contact with the nozzle opening surfaces of the heads 31 so as to separate the heads 31 and the caps 42 from each other (S07). With this, since the ink in the heads 31 has been pressurized with the pressure adjusting pump P2, ink is ejected powerfully through the nozzle openings. The controller 10 causes a predetermined amount of ink to be ejected through the nozzle openings, and then, stops the operation of the pressure adjusting pump P2 (releases the sub tank 45 to the atmosphere).

If ink is circulated with the circulation pump P3 while depressurizing the inner portion of the sub tank 45 with the pressure adjusting pump P2, air bubbles can be removed from ink in the heads 31 and the circulation tube 47 and the heads 31 and the circulation tube 47 can be filled with ink. However, fine spaces such as the nozzles Nz are difficult to be filled with the ink and there arises a risk in that the air (air bubbles) is present in the nozzles Nz after the ink has been circulated with the circulation pump P3. Therefore, after the ink circulation, the ink in the heads 31 is pressurized with the pressure adjusting pump P2 so that ink is ejected through the nozzle openings. With this, the air is discharged from the nozzles Nz together with the ink and the nozzles Nz can be filled with the ink.

An amount of ink to be ejected through the nozzle openings by the pressurization with the pressure adjusting pump P2 is set to an ink amount which is equal to or larger than volumes of spaces which are filled with ink, that is, an amount of ink that is contained in the nozzles Nz. Further, the amount of ink to be ejected through the nozzle openings is set to an ink amount which is smaller than a volume of the flow path circulated from the sub tank 45 to the sub tank 45, that is, an ink amount which is smaller than an amount of ink contained in the circulation tube 47 and the four heads 31(1) to 31(4).

With such maintenance processing (FIG. 4), the heads 31 and the circulation tube 47 can be filled with ink while removing air bubbles from ink in the heads 31 and the circulation tube 47.

To summarize the above description, the printer 1 in the embodiment includes the sub tanks 45 (corresponding to a liquid storing unit) that store ink (liquid), the pressure adjusting pumps P2 (corresponding to a pressure adjusting unit) that adjust a pressure in the sub tanks 45, the circulation tubes 47 (corresponding to a circulation flow path) that return the inks that have flowed out from the sub tanks 45 to the sub tanks 45 again, the circulation pumps P3 (corresponding to a circulating unit) that circulate the inks in the circulation tubes 47, the heads 31 that are provided halfway on the circulation tubes 47 and are capable of ejecting the inks through a plurality of nozzle openings, the caps 42 that are capable of abutting against nozzle opening surfaces of the heads 31, and the controller 10 (corresponding to a control unit) that depressurizes inner portions of the sub tanks 45 to a pressure lower than the atmospheric pressure with the pressure adjusting pumps P2 when the inks in the circulation tubes 47 are circulated by the circulation pumps P3 in a state where the caps 42 are made to abut against the nozzle opening surfaces of the heads 31 so as to seal the plurality of nozzle openings individually.

That is to say, in the printer 1 in the embodiment, ink is circulated while depressurizing an inner portion of each ink circulation path (sub tank 45, circulation tube 47, heads 31).

With this, a flow speed of ink flowing into each sub tank 45 can be made higher while making air bubbles contained in ink in the heads 31 and each circulation tube 47 expand. As a result, fine air bubbles that remain in places (corner portions, narrow spaces, junctions of members) in which the air bubbles are easy to remain expand so as to make these expanded air bubbles easily flow with the current of ink. This makes it possible to transfer more air bubbles to each sub tank 45.

Further, the fine air bubbles mixed into the ink in each sub tank 45 can be made to expand, and the expanded air bubbles can be made easy to go up to an ink liquid surface and disappear. This makes it possible to prevent the ink containing the air bubbles from being transferred from each sub tank 45 to each circulation tube 47 and the heads 31.

That is to say, the maintenance method by the printer 1 in the embodiment can reduce air bubbles contained in ink in the heads 31 and each circulation tube 47 in comparison with a maintenance method which does not depressurize the inner portion of each sub tank 45 with each pressure adjusting pump P2 so as to improve air bubbles removing performance from ink.

Further, in the printer 1 in the embodiment, after the controller 10 has circulated the ink in each circulation tube 47 with each circulation pump P3, the controller 10 pressurizes the inner portion of each sub tank 45 to a pressure higher than the atmospheric pressure with each pressure adjusting pump P2 and releases close contact between the heads 31 and the caps 42 so as to cause the ink to be ejected through the nozzle openings of the heads 31. It is to be noted that a configuration in which after the controller 10 has released the close contact between the heads 31 and the caps 42, the controller 10 pressurizes the inner portion of each sub tank 45 with each pressure adjusting pump P2 so as to cause the ink to be ejected through the nozzle openings may be employed.

With this, fine spaces such as the nozzles Nz which are difficult to be filled with ink can be filled with the ink. Therefore, an appropriate amount of liquid can be ejected through the nozzle openings.

Further, as in the printer 1 in the embodiment, if ink is circulated while depressurizing the inner portion of each ink circulation path, a space in which air bubbles (air) are present in the heads 31 and each circulation tube 47, that is, a space which is not filled with ink can be made only to spaces in the nozzles Nz. Therefore, an amount of ink to be ejected through the nozzle openings by pressurization with each pressure adjusting pump P2 after the ink circulation can be set approximately to a volume of spaces in the nozzles Nz.

If ink is circulated without depressurizing the inner portion of the sub tank 45 with each pressure adjusting pump P2, air bubbles remain in the ink in the heads 31 and each circulation tube 47 even after the ink circulation. Therefore, ejection failure or the like occurs due to the air bubbles unless an amount of ink to be ejected through the nozzle openings by pressurization with each pressure adjusting pump P2 after the ink circulation is set to an ink amount which is equal to or larger than a volume of the flow path circulated from each sub tank 45 to each sub tank 45 (that is, an ink amount which is equal to or larger than an amount of ink contained in each circulation tube 47 and the four heads 31(1) to 31(4)).

That is to say, as in the printer 1 in the embodiment, if ink is circulated while depressurizing the inner portion of the ink circulation path so as to remove more air bubbles from the ink, an amount of ink to be ejected through the nozzle openings by pressurization with each pressure adjusting pump P2 after the ink circulation can be reduced. That is to say, in the printer 1 in the embodiment, maintenance processing with a reduced amount of ink to be consumed can be executed.

Further, each circulation tube 47 includes the outbound tube 47a (corresponding to an outbound flow path) that makes the ink that has flowed out from each sub tank 45 flow into the heads 31, and the inbound tube 47b (corresponding to an inbound flow path) that returns the ink that has flowed out from the heads 31 to each sub tank 45. That is to say, the heads 31 (common ink chambers 312) are constituted as a part of the ink circulation path.

Therefore, even if air bubbles which have been present in each outbound tube 47a at the upstream side with respect to the heads 31 flow into the heads 31 together with ink, the ink containing the air bubbles can be made to flow out from each inbound tube 47b so as to be returned to each sub tank 45. Accordingly, an amount of air bubbles contained in the heads 31 can be further reduced so as to reduce an amount of ink to be ejected through the nozzle openings by pressurization with each pressure adjusting pump P2 after the ink circulation.

### Modifications

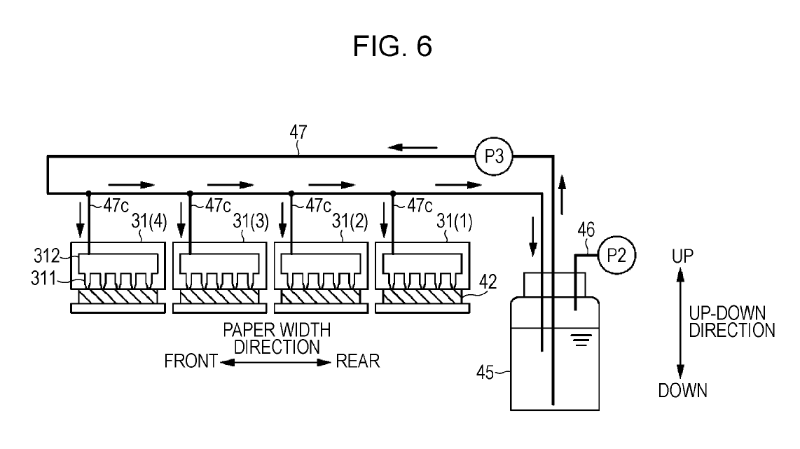

FIG. 6 is a view for explaining an ink circulation path in a modification. In the ink circulation path (FIG. 3) in the above-described embodiment, the outbound tube 47a which makes ink flow into the heads 31 and the inbound tube 47b which makes ink flow out from the head 31 are provided. However, the invention is not limited thereto. As in the modification, an ink circulation path in which the heads 31 communicate with only branch tubes 47c branched halfway on the circulation tube 47 may be provided. In this case, air bubbles contained in ink in the circulation tube 47 can be returned to the sub tank while supplying ink in the sub tank 45 to the heads 31.

However, in a case of this configuration, air bubbles contained in ink in the heads 31 are difficult to be returned to the sub tank. Therefore, it is desirable that the inner portion of the sub tank 45 is pressurized with the pressure adjusting pump P2 after the ink circulation and an ink amount which is equal to or larger than volumes of the heads 31 is ejected through the nozzle openings together with the air bubbles. With this, the air bubbles contained in the ink in the heads 31 can be removed.

Further, in the above-described embodiment, ink in the ink cartridge 43 has been supplied to the sub tank 45 once before being supplied to the heads 31. However, the invention is not limited thereto. For example, ink may be circulated with a circulation tube which connects the ink cartridge 43 and the heads 31 without providing the sub tank 45, for example.

Further, with the maintenance method (FIG. 4) in the above-described embodiment, after ink has been circulated in a state where the sub tank 45 is opened to the atmosphere, the inner portion of the sub tank 45 is depressurized with the pressure adjusting pump P2. However, the invention is not limited thereto. For example, the inner portion of the sub tank 45 may be depressurized with the pressure adjusting pump P2 at the same time when circulation of ink is started with the circulation pump P3.

Further, in the maintenance method in the above-described embodiment, after ink has been circulated with the circulation pump P3, the inner portion of the sub tank 45 is pressurized with the pressure adjusting pump P2 so as to cause ink to be ejected through the nozzle openings. However, the invention is not limited thereto. It is sufficient that ink is circulated with the circulation pump P3 only.

### Other Embodiments

In the above-described embodiment, the liquid ejecting apparatus is mainly described. However, a disclosure of a liquid ejecting apparatus maintenance method and the like is also included. The above-described embodiment is intended to make the invention understood easily and is not for limiting interpretation of the invention. It is needless to say that the invention can be changed and improved without departing from the scope of the invention, and understood as including equivalents thereof.

### Liquid Ejecting Apparatus

In the above-described embodiment, an ink jet printer is exemplified as a liquid ejecting apparatus. However, the liquid ejecting apparatus is not limited thereto. For example, the liquid ejecting apparatus may be liquid ejecting apparatuses such as a color filter manufacturing apparatus, a display manufacturing apparatus, a semiconductor manufacturing apparatus, and a DNA chip manufacturing apparatus.

### Printer

In the above-described embodiment, the printer 1 in which the medium S passes through the lower side of the fixed heads 31 has been described. However, the invention is not limited thereto. For example, the printer may be a printer in which an operation of ejecting ink from a head which moves in a predetermined direction and an operation of transporting the medium in a direction intersecting with the predetermined direction are repeated. Alternatively, the printer may be a printer in which an operation of ejecting ink from a head which moves in a predetermined direction and an operation of moving the head with respect to the medium in a direction intersecting with the predetermined direction are repeated.

The entire disclosure of Japanese Patent Application No. 2011-181293, filed Aug. 23, 2011 is expressly incorporated by reference herein.

What is claimed is:

1. A liquid ejecting apparatus comprising:
a liquid storing unit that stores liquid;
a pressure adjusting unit that adjusts a pressure in the liquid storing unit;
a circulation flow path that returns the liquid that has flowed out from the liquid storing unit to the liquid storing unit again;
a circulating unit that circulates the liquid in the circulation flow path;
a head that is provided halfway in the circulation flow path and is capable of ejecting the liquid through a plurality of nozzle openings;
a cap that is capable of abutting against a nozzle opening surface of the head, and
a control unit that depressurizes an inner portion of the liquid storing unit to a pressure lower than an atmospheric pressure with the pressure adjusting unit when the liquid in the circulation flow path is circulated with the circulating unit in a state where the cap is made to abut against the nozzle opening surface of the head so as to seal the plurality of nozzle openings.

2. The liquid ejecting apparatus according to claim 1,
wherein the control unit circulates the liquid in the circulation flow path with the circulating unit, and then, pressurizes an inner portion of the liquid storing unit to a pressure higher than the atmospheric pressure with the pressure adjusting unit so as to cause the liquid to be ejected through the nozzle openings.

3. The liquid ejecting apparatus according to claim 1,
wherein the circulation flow path includes an outbound flow path that makes the liquid that has flowed out from the liquid storing unit flow into the head, and an inbound flow path that returns the liquid that has flowed out from the head to the liquid storing unit.

4. A liquid ejecting apparatus maintenance method by the liquid ejecting apparatus according to claim 1.

5. A liquid ejecting apparatus maintenance method by the liquid ejecting apparatus according to claim 2.

6. A liquid ejecting apparatus maintenance method by the liquid ejecting apparatus according to claim 3.
